(19) United States
(12) Patent Application Publication
(10) Pub. No.: US 2026/0256054 A1
(43) Pub. Date: Sep. 3, 2026

(54) Straw Chopper for a Combine Harvester

(71) Applicant: AGCO do Brasil Soluções Agrícolas Ltda., Ribeirao Preto (BR)

(72) Inventor: Marcelo Carpenedo, Sapucaia do Sul (BR)

(21) Appl. No.: 19/068,644

(22) Filed: Mar. 3, 2025

(51) Int. Cl. A01D 41/12

(52) U.S. Cl. CPC A01D 41/1243

(57) ABSTRACT

A straw chopper for a combine harvester has a set of hub blades extending outwardly from a central hub and a set of drum blades (forming a stationary knives group) interleaved with the hub blades. An adjustment system is used for adjusting the inward extent of the drum blades. It has a rotary handle, worm gear rotated by the rotary handle and a control shaft coupled to and rotated by the worm gear. An adjustment plate is coupled to the control shaft and the drum blades are moved by movement of the adjustment plate.

### CROSS-REFERENCE TO RELATED APPLICATIONS

This application claims the benefit of the filing date of U. K. Provisional Patent Application 2403515.6, “A Straw Chopper for a Combine Harvester,” filed Mar. 11, 2024, the entire disclosure of which is incorporated herein by reference.

### FIELD

Embodiments of the present disclosure relate generally to combine harvesters, and in particular to a straw chopper spreader used within a combine harvester.

### BACKGROUND

A combine harvester typically includes a threshing system for detaching grains of cereal from material other than grain, such as cobs, stems and seed pods, a separating apparatus downstream of the threshing system, and a grain cleaning apparatus (known as the cleaning shoe) for receiving grain from the separating apparatus. A stratification pan aims to stratify the material into a layered structure of grain at the bottom and light chaff and other material other than grain (MOG) at the top. The grain is collected in a grain bin, and from the grain bin the grain can be unloaded, for example to a trailer pulled by a tractor which runs alongside the combine harvester.

It is well known to install chaff spreaders for collecting and distributing MOG (i.e., chaff) ejected from the rear of the cleaning shoe. A chaff spreader for example comprises a pair of fan modules which eject the chaff at a tangent to a fan rotation axis.

It is also well known to install a straw chopper behind the threshing and separating apparatus for cutting straw, and to use a straw spreader to distribute the cut straw over the field. The straw chopper for example comprises a set of rotating blades which extend radially outwardly from a central hub, within a chopper drum. The chopper extends across the width of the combine, and rows of multiple blades are pivotally fixed around the circumference of the central hub.

The straw spreader typically comprises rotary spinners (impellers) which drive the material into an output channel with a desired outlet direction. For example, a typical straw spreader has a pair of spinners, to actively accelerate the chopped straw and spread it at the back of the combine.

One main challenge is to improve the straw quality in terms of how well it is chopped, namely the target chopping length and the percentage of the material that is correctly cut to that target length.

There are many known design features which aim to improve the chopping consistency and reduce the chopping length. One example is the so-called “Material Brake”. The material brake is a step feature applied on the chopper floor which disturbs the material flow around the chopper drum, forcing the straw to stop or reduce its motion when hitting the feature, allowing that the chopper blades to pass through that specific portion of straw and cut the material an increased number of times. The material brake is designed to be movable, enabling it to be engaged or not engaged on the chopper floor, according to the customer needs.

Another example is the use of a so-called “Counter Knives Group”. This is a set of stationary knives mounted to the drum placed along the chopper drum floor. They function to force the material to pass through a scissor type arrangement, to further decrease the size of the material being chopped.

These known features improve the material cutting process inside the chopper, essentially by forcing the straw to have more contact with the chopper knives.

It is known to have an adjustable position of the counter knives group. This is typically implemented by manual handles positioned on both sides of the residue management system. The handles basically define the counter knives group positioning and, once the desired positioning has been selected, the system is locked by pins or bolts. Electrical or hydraulic solutions have also been proposed, whereby the manual handles are replaced by automated concepts. The aim of these solutions is to enable adjustment of the counter knives group from the cabin and also eliminate the need for human force to perform the counter knives movement. However, this is a high cost solution, in particular relative to the number of times that this adjustment is needed (only few times during the harvesting season for a given crop type).

US 2007/0004479 discloses a straw chopper with adjustable stationary knife blades, using a handle which is coupled to the knife blades through pivoted linkage arms. A wing nut is used to fix the linkage arms and thus hold the knife blades in their chosen position.

### BRIEF SUMMARY

The invention is defined by the claims.

According to examples in accordance with this disclosure, there is provided a straw chopper for a combine harvester, comprising:
an outer drum portion;
a central hub within the outer drum portion, the central hub having a length, and a rotation axis along the length direction;
a set of hub blades extending outwardly from the central hub;
a set of drum blades coupled to the outer drum portion, the drum blades being static in use and extending inwardly towards the central hub, interleaved with the hub blades; and;
an adjustment system for adjusting the inward extent of the drum blades, wherein the adjustment system comprises a rotary handle and an adjustment unit driven by the rotary handle, wherein the adjustment unit comprises:
   a worm gear rotated by the rotary handle;
   a control shaft coupled to and rotated by the worm gear; and
   an adjustment plate coupled to the control shaft, wherein the drum blades are moved by movement of the adjustment plate.

This design of adjustable stationary drum blades (known as the counter knives group) provides a simple and low-cost way to adjust the drum blades. A rotary handle is coupled to a control shaft by a worm gear. This allows for a straightforward change in the position of the counter knives group and avoids the need to lock the knives group in position. The manual adjustment system eliminates the necessity for a high-tech automation setup in the cab or the use of elevated manual force.

The adjustment plate for example comprises a threaded bore which receives a threaded end of the control shaft. Thus, the handle rotation is converted to a rotation of the control shaft, and this in turn is converted to linear movement of the threaded bore attached to the adjustment plate. These various couplings lock the position of the drum blades without needing a separate locking system.

The adjustment plate is for example pivotally connected to a fixed frame of the straw chopper. Thus, it pivots between operative positions during adjustment.

The adjustment plate for example comprises a guide slot, and the straw chopper comprises a control rod of the drum blades which passes through the guide slot. A position of the control rod within the guides slot changes when the position of the drum blades is adjusted.

The control rod for example also passes through a second guide slot in the fixed frame of the straw chopper. Thus, the control rod follows a defined path along the second guide slot. At different locations along the second guide slot, the control rod will adopt different locations along the (first) guide slot of the adjustment plate.

The control rod of the drum blades for example extends between lateral sides of the straw chopper, and a lateral drive rod extends between lateral sides of the straw chopper, rotated by the rotary handle, wherein an adjustment unit is provided at each lateral side of the straw chopper. Thus, the position of the drum blades is set at both lateral ends, to provide a more stable adjustment. However, only one rotary handle is needed. The rotary handle rotates the drive rod, and it then has worm gears at each end which drive the adjustment units at both lateral sides of the straw chopper.

The set of hub blades for example comprises multiple blades along the length of the central hub and multiple blades around the central hub.

This disclosure also provides a combine harvester comprising:
a crop cutting head;
a threshing and separating system;
the straw chopper defined above for cutting MOG received from the threshing and separating system; and
a straw spreader receiving a straw flow from the straw chopper and distributing the straw.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of this disclosure will now be described, by way of example only, with reference to the accompanying drawings, in which:

FIG. 1 shows a combine harvester which may be adapted in accordance with this disclosure;

FIG. 2 shows one example of threshing system and grain cleaning apparatus in more detail;

FIG. 3 shows a first example of a known straw chopper and also shows a first known design feature in the form of a so-called material brake;

FIG. 4 shows another feature in the form of a so-called counter knives group;

FIG. 5 shows a straw chopper according to this disclosure.

FIG. 6 shows the design of the adjustment system in more detail;

FIG. 7 shows a first side view of the adjustment unit;

FIG. 8 shows a cross section of the arrangement of FIG. 7 to show a knife of the counter knives group;

FIG. 9 shows a second side view of the adjustment unit;

FIG. 10 shows a cross section of the arrangement of FIG. 9 to show a knife of the counter knives group;

FIG. 11 shows the straw chopper from the lateral side without the handle; and

FIG. 12 shown another end view of the lateral side with the handle.

### DETAILED DESCRIPTION

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

This disclosure provides a straw chopper for a combine harvester that has a set of hub blades extending outwardly from a central hub and a set of drum blades (forming a stationary knives group) interleaved with the hub blades. An adjustment system is used for adjusting the inward extent of the drum blades. It has a rotary handle, worm gear rotated by the rotary handle and a control shaft coupled to and rotated by the worm gear. An adjustment plate is coupled to the control shaft and the drum blades are moved by movement of the adjustment plate.

This disclosure relates to the design of a straw chopper for use with a combine harvester. However, a general outline of a combine harvester will first be provided.

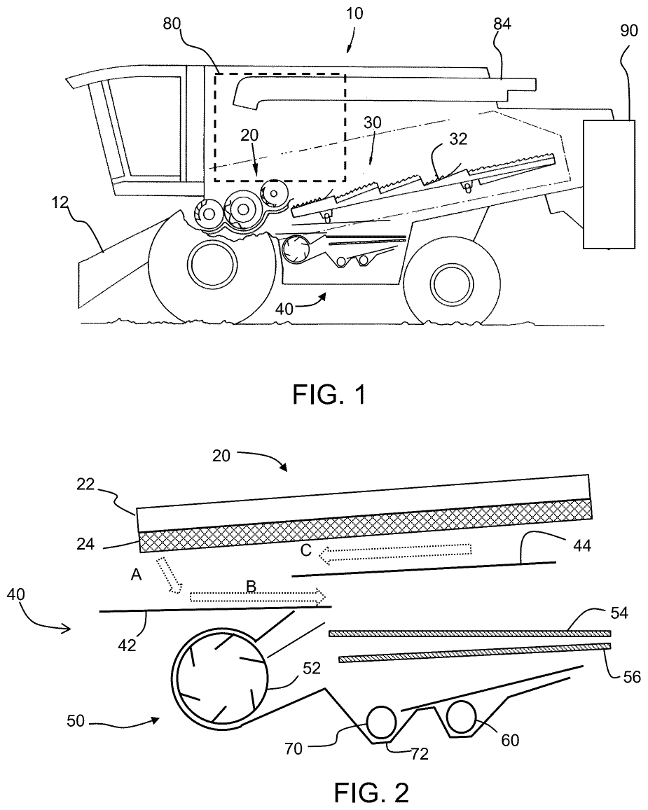

FIG. 1 shows a known combine harvester 10 to which this disclosure may be applied. The combine harvester includes a threshing system 20 for detaching grains of cereal from the ears of cereal, and a separating apparatus 30 which is connected downstream of the threshing system 20. The threshing system comprises one or more threshing units, in particular rotors, and associated concaves. In the example shown, the separating apparatus 30 includes a plurality of parallel, longitudinally-aligned, straw walkers 32, and this is suitable for the case of a so-called straw-walker combine. The grains after separation by the separating device 30 pass to a grain cleaning apparatus 40.

The grain cleaned by the grain cleaning apparatus is delivered to a grain bin 80 by a filling auger 70. Grain from the grain bin is removed from the combine harvester by an unloading tube 84.

The combine harvester has a front elevator housing 12 (known as a feederhouse) at the front of the machine for attachment of a crop cutting head (known as the header, not shown). The header when attached serves to cut and collect the crop material as it progresses across the field, the collected crop stream being conveyed up through the elevator housing 12 into the threshing system 20.

In the example shown, the threshing system 20 is a tangential-flow ‘conventional’ threshing system, i.e., formed by rotating elements with an axis of rotation in the side-to-side direction of the combine harvester and for generating a tangential flow. For example, the ‘conventional’ threshing system includes a rotating, tangential-flow, threshing cylinder and a concave-shaped grate. The threshing cylinder includes rasp bars (not shown) which act upon the crop stream to thresh the grain or seeds from the remaining material, the majority of the threshed grain passing through the underlying grate and onto a stratification pan (also sometimes known as the grain pan).

There are also axial threshing systems, i.e., formed by rotating elements with an axis of rotation in the longitudinal direction (direction of travel). For example, the threshing section may have axially-aligned rasp bars spaced around the front section whilst the separating section has separating elements or fingers arranged in a pattern, e.g., a spiral pattern, extending from the rasp bars to the rear of the rotor.

The MOG (material other than grain), in particular chaff, exits the combine harvester at the back. This disclosure relates to a straw chopper provided at the back of the combine harvester. The straw chopper is used in combination with a straw spreader, and they are together represented as unit 90 in FIG. 1.

As mentioned above, instead of tangential flow threshing (and separating), axial threshing (and separating) is also known, and this disclosure may be applied to any type of combine. For completeness, FIG. 2 shows an axial threshing and separating system 20, together with a more detailed view of the cleaning apparatus 40.

The threshing system 20 in this case comprises an axial rotor 22 beneath which is mounted the concave 24. The concave may have different sections along its length, and the first section to receive the crop material (to the left in FIG. 2) may have a releasable concave, or else the whole length of the concave may be releasable. The separating function for this type of combine involves conveying the crop stream rearwardly in a ribbon passing along a spiral path.

No matter what type of threshing is performed, the initial threshing creates a flow of grain to a stratification pan 42. The separating function further downstream of the threshing system serves to separate further grain from the crop stream and this separated grain passes through a grate-like structure onto an underlying return pan 44. The residue crop material, predominantly made up of straw, exits the machine at the rear. Although not shown in FIG. 1, a straw spreader and/or chopper may be provided to process the straw material as required.

The threshing apparatus 20 does not remove all material other than grain, “MOG”, from the grain so that the crop stream collected by the stratification pan 42 and return pan 44 typically includes a proportion of straw, chaff, tailings and other unwanted material such as weed seeds, bugs, and tree twigs. The remainder of the grain cleaning apparatus 40 is in the form of a grain cleaning unit 50. The grain cleaning unit 50 removes this unwanted material thus leaving a clean sample of grain to be delivered to the bin.

The grain cleaning unit 50 comprises a fan unit 52 and sieves 54 and 56. The upper sieve 54 is known as the chaffer.

The stratification pan 42 and return pan 44 are driven in an oscillating manner to convey the grain and MOG accordingly. Although the drive and mounting mechanisms for the stratification pan 42 and return pan 44 are not shown, it should be appreciated that this aspect is well known in the art of combine harvesters and is not critical to disclosure of the invention. Furthermore, it should be appreciated that the two pans 42, 44 may take a ridged construction as is known in the art.

The general flow of material is as follows. The grain passing through the concave 24 falls onto the front of stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the concave further back falls onto the return pan 44 and is conveyed forwardly by the oscillating motion and ridged construction thereof as shown by arrow C.

It is noted that “forwardly” and “rearwardly” refer to direction relative to the normal forward direction of travel of the combine harvester.

When the material reaches a front edge of the return pan 44 it falls onto the stratification pan 42 and is conveyed as indicated by arrow B.

The combined crop streams thus progress rearwardly towards a rear edge of the stratification pan 42. Whilst conveyed across the stratification pan 42, the crop stream, including grain and MOG, undergoes stratification wherein the more dense grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the grain to pass through the chaffer onto an underlying second sieve 56.

The chaffer 54 is coarser (with larger holes) than second sieve 56. Grain passing through chaffer 54 is incident on the lower sieve 56 which is also driven in an oscillating manner and serves to remove tailings from the stream of grain before being conveyed to the on-board bin by the filling auger 70 which resides in a transverse trough 72 at the bottom of the grain cleaning unit 50. Tailings blocked by sieve 56 are conveyed rearwardly by the oscillating motion thereof to a rear edge from where the tailings are directed to the returns auger 60 for reprocessing in a known manner. The grain is for example smaller and denser and generally more aerodynamic than MOG, therefore, less susceptible to being conveyed rearward by the chaffer/sieve and/or blown out of the rear of the machine by the air stream of the cleaning fan, passing upward and rearward, through the chaffer.

All material which has not been collected by the filling auger 70 or returns auger exits the back of the combine harvester and passes to a chaff spreader. The chaff spreader receives the rejected material from the cleaning shoe.

As explained above, it is known to provide a straw chopper and straw spreader for the straw output by the separating apparatus, such as the straw walker and this disclosure relates in particular to the design of the straw chopper.

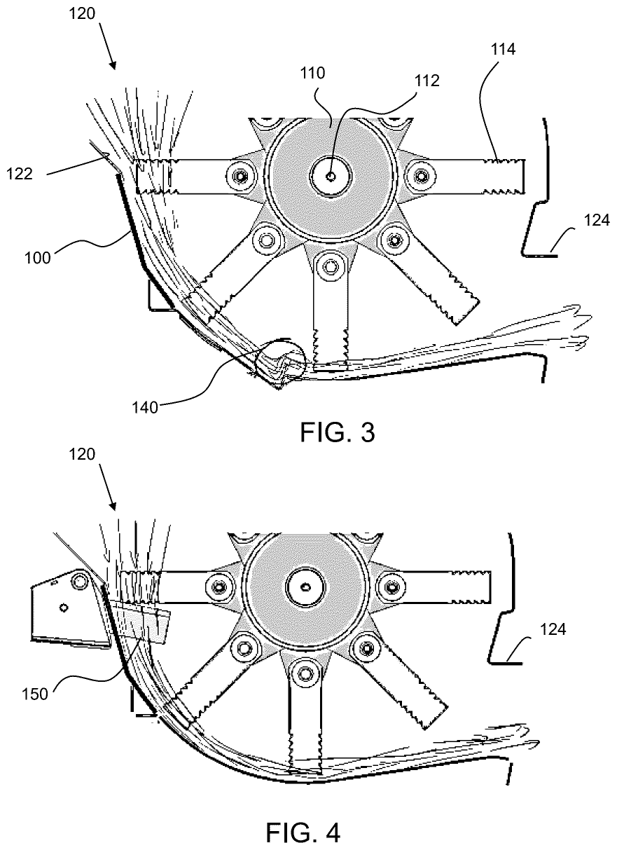

FIG. 3 shows a first example of a known straw chopper, comprising an outer drum 100 and a central hub 110 within the outer drum. The central hub has a length along a rotation axis 112. Blades 114 extend outwardly from the central hub, with serrated ends. The blades are pivotally attached to the central hub 110. In this example, there are four blades disposed at 90 degree intervals (forming a set) around the central hub. Adjacent sets are offset by 45 degrees, so that eight blades can be seen in end view.

A feeding channel 120 is defined between the outermost ends of the blades 114 and the outer drum 100. The feeding channel has an inlet 122 which extends along substantially the full length of an inlet opening of the outer drum and the feeding channel has an outlet 124 also along substantially the full length of the outer drum. The inlet and outlet are angularly offset around the rotation axis 112 by less than 180 degrees for example around 100 degrees. A small portion of drum wall is adjacent the outlet 124, to define the outlet channel shape and thereby limit the area where the straw is discharged. The drum is otherwise open at the top.

The blades rotate faster than the flow of crop material, i.e., the radially outermost ends of the blades have a linear speed which is greater than the linear flow speed of the straw flow.

FIG. 3 shows a first known additional design feature in the form of the so-called material brake 140 mentioned above. It is a step applied to the floor of the outer drum which disturbs the material flow around the drum, forcing the straw to stop or reduce its motion when hitting the step so that the chopper blades cut the material an increased number of times. The material brake is for example designed to be movable, enabling it to be engaged or not engaged on the chopper floor, according to the customer needs.

FIG. 4 shows another feature in the form of a so-called counter knives group 150. It comprises stationary blades mounted to the drum and interleaved with the rotating blades. It holds back the straw so that the rotating knives cut the held back straw. The knives of the counter knives group function to force the material to pass through a scissor type arrangement, to further decrease the size of the material being chopped.

Each rotating blade may comprise a spaced pair of blade elements, and they pass each side of an associated knife of the counter knives group 150. It is also known to provide a serrated bar at the bottom wall of the outer drum, again for increasing the number of cuts made to the straw.

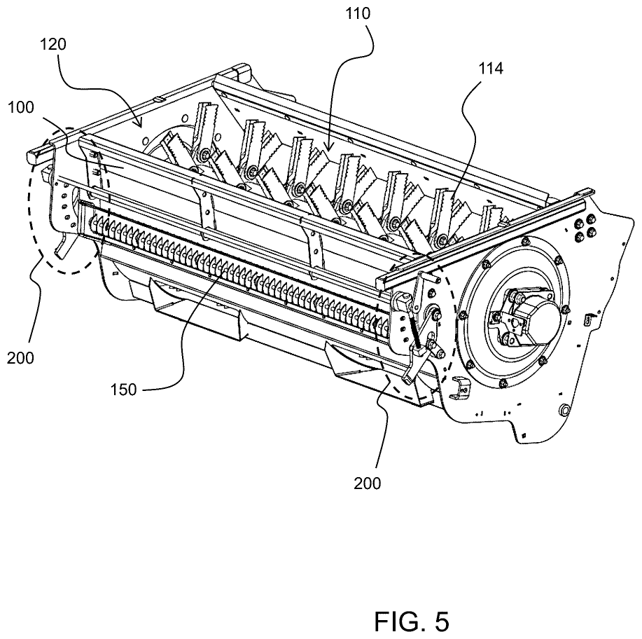

This disclosure relates to the adjustment of the counter knives group. FIG. 5 shows a straw chopper according to this disclosure.

As with the known designs, the straw chopper has an outer drum portion 100 and a central hub 110 within the outer drum portion which carries a set of hub blades 114 extending outwardly from the central hub. A feeding channel 120 is defined between the outermost ends of the hub blades and the outer drum portion.

A set of drum blades 150 is coupled to the outer drum portion. These “drum blades” are the blades generally known as the counter knives group, and they remain static in use. They extend inwardly towards the central hub, interleaved with the hub blades as explained with reference to FIG. 4.

This disclosure provides an adjustment system 200 for adjusting the inward extent of the drum blades 150. As shown in FIG. 5, the adjustment system 200 has elements at both lateral sides of the straw chopper.

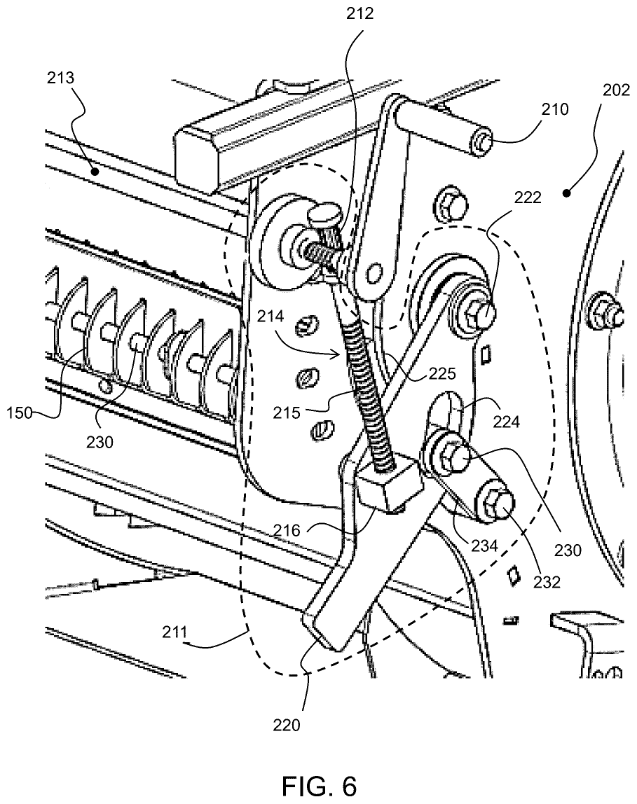

The design of the adjustment system is shown in more detail in FIG. 6. FIG. 6 shows one lateral side, and in particular a side that includes a rotary handle 210. The rotary handle drives an adjustment unit 211. There are adjustment units 211 at both lateral sides of the straw chopper, but only one handle is needed. The rotary handle rotates a lateral drive rod 213 which extends between the two lateral sides so that it actuates the two adjustment units. This drive rod has a worm gear 212 at each end. The worm gear is thus rotated by the rotary handle.

A control shaft 214 is coupled to and rotated by the worm gear. Thus, it has a complementary worm gear that meshes with the worm gear of the lateral drive rod. The two meshed worm gears are for example part of an enclosed unit rather than being exposed as is shown in FIG. 6.

An adjustment plate 220 is coupled to the control shaft 214, and the drum blades 150 are moved by movement of the adjustment plate 220. The drum blades are thus coupled to the adjustment plate so that movement of the adjustment plate entrains movement of the drum blades. The drum blades are moved generally radially in and out, so that the extent to which they are deployed is controllable. In particular, the adjustment plate 220 has a threaded bore 216 which receives a threaded end 215 of the control shaft 214. Thus, the handle rotation is converted to a rotation of the control shaft 214, and this in turn is converted to linear movement of the threaded bore 216 attached to the adjustment plate 220.

The adjustment plate rotates about a pivotal connection 222 to a fixed frame 202 of the straw chopper. Thus, it pivots between operative positions during adjustment. The handle rotation alters the distance between the control shaft 213 and the threaded bore 216 and this in turn causes rotation of the adjustment plate 220. During this rotation, there is engagement between a guide slot 224 of the adjustment plate and a control rod 230 of the drum blades 150. There is a second guide slot 225 in the frame of the straw chopper. The control rod 230 moves along the second guide slot 225 so that the adjustment plate can rotate up and down during adjustment.

The adjustment unit 211 further has a link arm 234 connected between the control rod 230 and a further rod 232. Both of the control rods 230, 232 move along the second guide slot 225 during adjustment, and the shape of the second guide slot thereby dictates the path followed by the counter knives group. The counter knives group is fixed to the control rods 230, 232. The counter knives group is thus moved by the adjustment plate driving the control rod 230. By having engagement between both rods 230, 232 and the second guide slot 225, a rotational orientation of the drum blades is also controlled as the rods 230, 232 move along the second guide slot 225. The guide slot 224 allows this rotational orientation to change as the rods move along the second guide slot 225.

By having two adjustment units, the position of the drum blades is set at both lateral ends, to provide a more stable adjustment. However, only one rotary handle is needed. The rotary handle rotates the drive rod 213, and it then has worm gears at each end which drive the adjustment units 211 at both lateral sides of the straw chopper.

This design of adjustable stationary drum blades provides a simple and low-cost way to adjust the counter knives group. A straightforward change in the position of the counter knives group is enabled and the gearing system avoids the need to lock the knives group in position. The manual adjustment system eliminates the necessity for a high-tech automation setup in the cab or the use of elevated manual force. In particular, the use of a rotary handle and worm gear provides a simple way to amplify the force applied so that adjustment can be made even when there is dust blockage in the system.

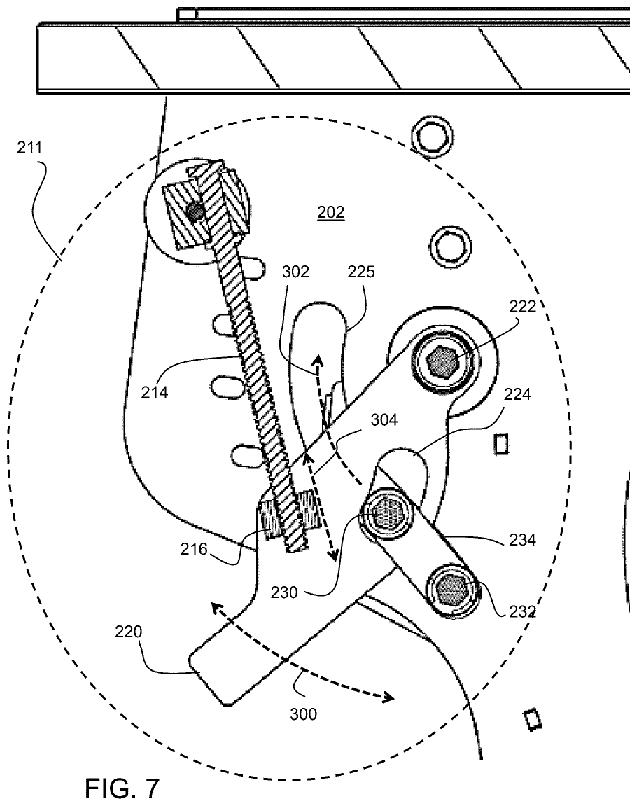

FIG. 7 shows a side cross sectional view of the adjustment unit. It shows with arrow 300 the movement of the adjustment plate 220, with arrow 302 the movement of the link arm 234 along the second guide slot 225, and with arrow 304 the movement of the threaded bore 216. The block 216 can pivot on the plate 220 so that it follows the orientation of the control shaft 214.

In FIG. 7 (and FIG. 6), the control rod 230 is at one end of the guide slot 224, and the second rod 232 is at the end of the second guide slot 225. This is one extreme position of the counter knives group, in particular with the adjustment plate at a lowest position (rotated counterclockwise as viewed in FIG. 7) and the counter knives group fully extended (i.e., in use).

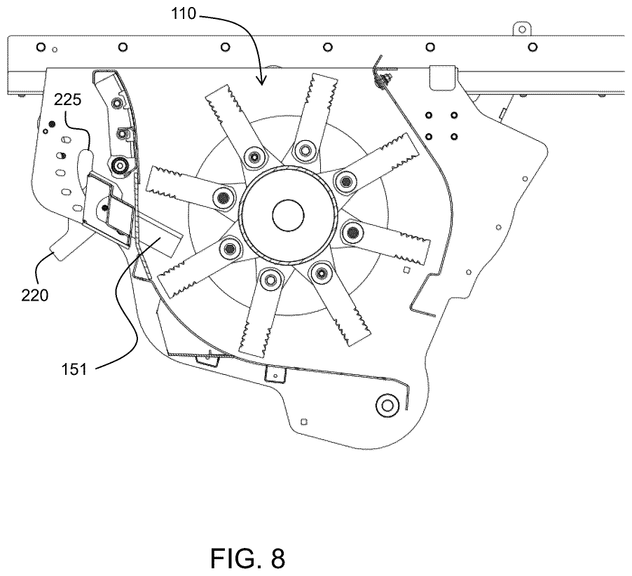

FIG. 8 shows a cross section of the arrangement of FIG. 7 in which a knife 151 of the counter knives group 150 can be seen, to show the orientation of the knife when extended.

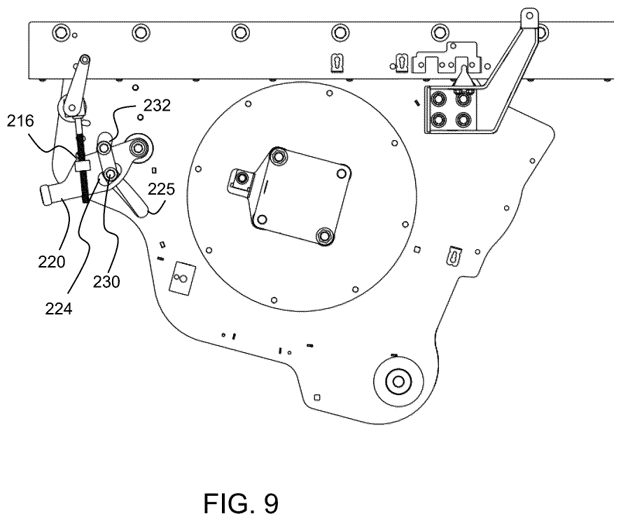

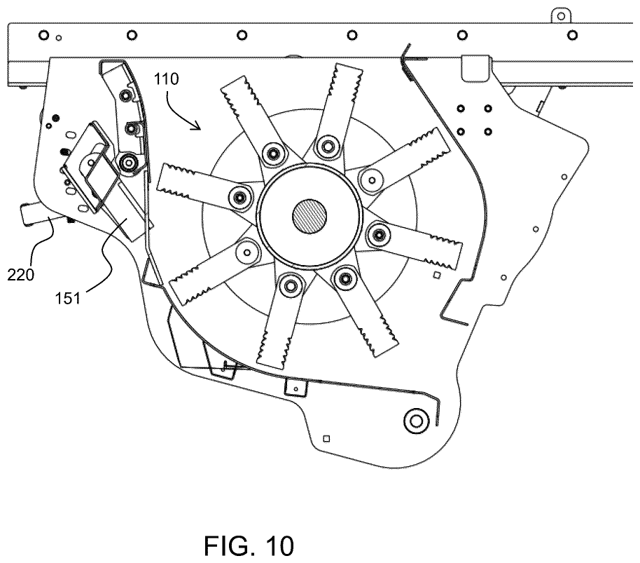

FIG. 9 shows a side end view in which the block 216 has been moved up relative to the configuration shown in FIG. 7, so that the adjustment plate 220 is rotated clockwise (as viewed in FIG. 9) about its pivotal connection 222 to an upper position (and the control rod 230 is near the other end of the guide slot 224). FIG. 9 (and FIG. 10) also shows a slightly different design in which the control rod 230 (in the guide slot 224) is the lower of the two rods 230, 232 whereas in the other figures the control rod 230 is the higher of the two rods 230, 232. The second rod 232 in this example is near the top of the second guide slot 225 and hence this is close to an opposite extreme position of the counter knives group, in particular with the adjustment plate at a highest position (rotated clockwise) and the counter knives group fully retracted.

FIG. 10 shows a cross section of the arrangement of FIG. 9 in which a knife 151 of the counter knives group 150 can be seen, to show the orientation of the knife when retracted.

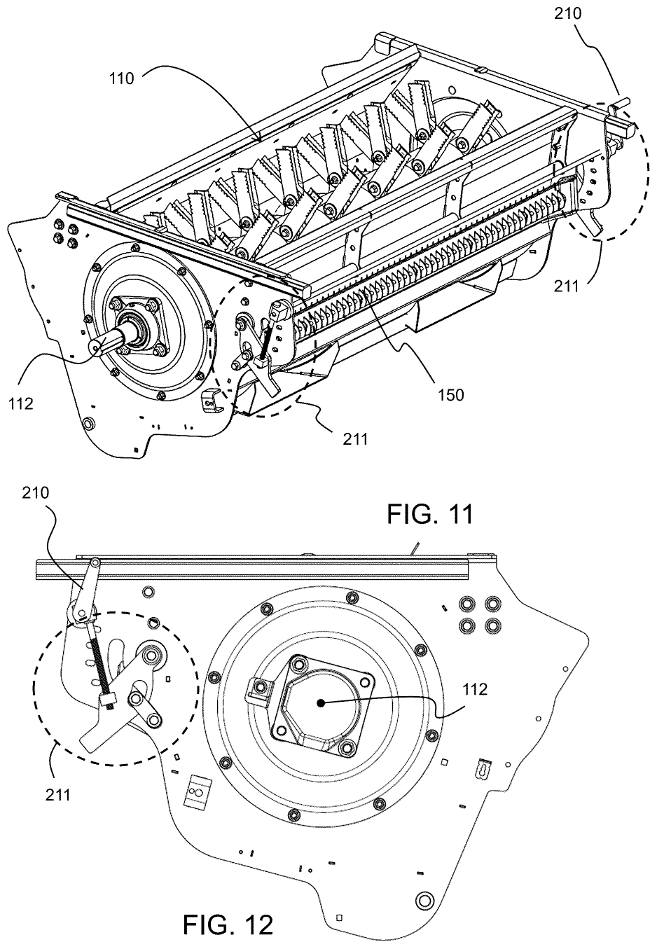

FIG. 11 shows the straw chopper from the lateral side without the handle and FIG. 12 shown another end view of the lateral side with the handle.

The teachings in this disclosure may be applied to any design of combine harvester. Thus, it does not rely on any particular threshing, separating or cleaning design, and the examples above are only given to aid overall understanding.

Within the scope of this application, it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

Any reference signs in the claims should not be construed as limiting the scope.

All references cited herein are incorporated herein in their entireties. If there is a conflict between definitions herein and in an incorporated reference, the definition herein shall control.

What is claimed is:

1. A straw chopper for a combine harvester, comprising:
an outer drum portion;
a central hub within the outer drum portion, the central hub having a length, and a rotation axis along the length direction;
a set of hub blades extending outwardly from the central hub;
a set of drum blades coupled to the outer drum portion, the drum blades being static in use and extending inwardly towards the central hub, interleaved with the hub blades; and
an adjustment system for adjusting the inward extent of the drum blades,
wherein the adjustment system comprises a rotary handle and an adjustment unit driven by the rotary handle, wherein the adjustment unit comprises:
a worm gear rotated by the rotary handle;
a control shaft coupled to and rotated by the worm gear; and
an adjustment plate coupled to the control shaft, wherein the drum blades are moved by movement of the adjustment plate.

2. The straw chopper of claim 1, wherein the adjustment plate comprises a threaded bore which receives a threaded end of the control shaft.

3. The straw chopper of claim 1, wherein the adjustment plate is pivotally connected to a fixed frame of the straw chopper.

4. The straw chopper of claim 1, wherein the adjustment plate comprises a guide slot, and the straw chopper comprises a control rod of the drum blades which passes through the guide slot.

5. The straw chopper of claim 4, wherein the control rod passes through a second guide slot in a fixed frame of the straw chopper.

6. The straw chopper of claim 4, wherein the control rod of the drum blades extends between lateral sides of the straw chopper, and a lateral drive rod extends between lateral sides of the straw chopper, rotated by the rotary handle, wherein an adjustment unit is provided at each lateral side of the straw chopper.

7. The straw chopper of claim 1, wherein the set of hub blades comprises multiple blades along the length of the central hub and multiple blades around the central hub.

8. A combine harvester comprising:
a crop cutting head;
a threshing and separating system;
the straw chopper of claim 1 for cutting MOG received from the threshing and separating system; and
a straw spreader receiving a straw flow from the straw chopper and distributing the straw.
